(19) United States
(12) Patent Application Publication
(10) Pub. No.: US 2014/0207413 A1
(43) Pub. Date: Jul. 24, 2014

(54) SYSTEM FOR OBTAINING STATISTICAL INFORMATION

(71) Applicant: Avraham Yehuda Hamaoui, Lawrence, NY (US)

(72) Inventor: Avraham Yehuda Hamaoui, Lawrence, NY (US)

(21) Appl. No.: 13/834,075

(22) Filed: Mar. 15, 2013

Related U.S. Application Data
(60) Provisional application No. 61/756,174, filed on Jan. 24, 2013.

(51) Int. Cl. G06F 17/18

(52) U.S. Cl. CPC G06F 17/18
USPC 702/179

(57) ABSTRACT

A system for obtaining and presenting statistical information about people and articles as well as establishing anonymous communities among people that share one or more personal traits. Users may create a personal profile containing user selected personal information. Users may also vote on various polls. Users may create visual representations such as graphs and tables correlating user selectable data from the information within databases storing user personal profile information, user voting history, time, and others.

### CROSS-REFERENCE TO RELATED APPLICATION

This application claims the benefit, under 35 U.S.C. §119(e), of U.S. Provisional Pat. App. Ser. No. 61/756,174, filed Jan. 24, 2013, the entire contents of which is hereby incorporated by reference herein in its entirety.

### FIELD OF THE INVENTION

The present invention relates to software such as a website for creating polls on various topics for which users may cast votes. The present invention further relates to software providing a database from which users may select desired aspects to correlate for statistical research. The present invention further relates to an internet based social network in which users may remain anonymous.

### BACKGROUND

Presently, there does not exist an easily and publicly accessible, comprehensive, and easily utilized library of source information for statistical research; particularly, relating to people. The process of conducting statistical research is laborious, expensive, and otherwise incapable, as will be discussed below. There exists a need for a centralized database containing vast amounts of normalized information for easy utilization in statistical research. Additionally, there exists a need for tools enabling a researcher to efficiently browse and analyze said information.

People are presented with many sources of statistical data, especially about people. These sources include television, radio, newspapers, magazines, the internet, word of mouth, etc. However, information gathered from such sources may be unreliable. For example, the information may be subject to inaccuracies due to biases or motivations of the source. Further, such inaccuracies may be difficult for a consumer to identify because they are not provided with the raw data upon which the statistical correlation was made.

Additionally, it is often difficult to obtain statistical information about certain topics. For example, most people cannot gain access to the medical records of others. Thus, only those in the medical profession may be capable of gathering such information. Moreover, such information could take years and be expensive to gather, correlate, and publish. Moreover, those polled may be reluctant to provide such personal information for fear of being associated with it. Another type of information that may be difficult to gather is that related to traits for which the owners are difficult to locate or identify for polling. For example, if one were to be interested in correlating certain purchasing habits of only those having more than four children, they may randomly survey a great many people while only encountering very few who fit the criteria for relevance. Such a process is highly inefficient. Otherwise, they may be left to guess where such people may gather in large numbers, but such places may be difficult to get to, difficult to poll, or may not even exist. This problem increases drastically when the interest is in surveying a group of people having multiple criteria such as people having more than four children who are also female, multilingual, and between the ages of 30-40.

Another shortcoming of current avenues of obtaining statistical information is that consumers are unable to conduct further research based on the given information. For example, a piece of statistical information as obtained via a conventional media avenue may correlate advocates of a particular law with their gender. However, if one were to be interested in further qualifying that data with age information of those surveyed, they would need to conduct the whole survey again from scratch.

Clearly, there exists a need for quickly obtaining accurate, reliable, statistical data correlating even aspects relating to sensitive information and individuals with traits that are difficult to locate or identify, while maintaining participant anonymity. Further, there exists a need for providing statistical information which users can easily repurpose for further study.

A shortcoming of current avenues of obtaining statistical information related to polls is that a participant may find that none of the available voting options, in a multiple choice poll, for example, accurately reflect the participants position. A participant may be forced to select a voting option that most closely reflects their position, but is not very accurate, in order to contribute to the poll. Such a practice may be a source of inaccuracy for the poll results.

Moreover, even when a poll is conducted through a source where it is technically possible for a participant or consumer to contact the poll provider and suggest alterations, the process of doing so is often difficult. For example, while a consumer may be able to contact a television broadcast company or the administrators of a website or the like, such providers may be difficult to persuade to alter a poll for a variety of reasons including mere logistics. Furthermore, even if such a provider was interested in accepting consumer suggestions, the consumer only is aware of the poll after it has been completed and it may be too late to contribute any suggestions.

Similarly, a shortcoming of conventional websites, software, or other media sources, is that a user must contact the administrators through the same channel (e.g. phone call, email) for any desired communication, even not related to poll voting options. A consumer may likely not be compelled to place a suggestion through such a channel as they may assume their suggestion is unlikely to be considered. Moreover, the administrators may become overwhelmed with the diverse nature of the phone calls and emails and fail to incorporate or even notice the suggestion due to inconvenience.

Another shortcoming of current avenues of obtaining statistical information related to polls is that those polled typically comprise only a small fraction of the population they are supposed to represent. This is true because it is often difficult or even impossible to poll the entire relevant population or even a large percentage thereof. Thus, the polls are subject to inaccuracies.

Another shortcoming of current avenues of obtaining statistical information related to polls is that, for many important topics, only those who happen to have been contacted by the surveyor are included. A consumer may be unable to volunteer their participation in a poll. Thus, the poll may be likely to ignore those who may be qualified to provide valuable information. Moreover, a consumer may be left feeling as if their opinions are not being considered by the general public or some subset thereof as they were unable to participate in the poll. This may be particularly problematic in a political spectrum where those without significant political voices or influence may feel slighted by those who possess such things.

Clearly, there exists a need for poll practices in which consumers can be more involved in the construction and participation of a poll. Furthermore, there exists a need for a system facilitating consumer interactions with administrators in which a consumer can be efficiently involved in directing administrator activity.

Another shortcoming of current avenues of obtaining statistical information relates to the need for researchers to limit the surveying criteria to only the criteria that may be expected to produce significant results. An attempt to correlate seemingly unrelated data may likely be costly and fruitless, and is thus discouraged. However, such correlations may prove valuable at times.

Clearly there exists a need to quickly and inexpensively correlate all sorts of data concerning any number of user desired aspects in any conceivable combination such that valuable trends may be discovered where it may otherwise have been too inefficient to look.

### SUMMARY OF THE PRESENT INVENTION

The present invention seeks to remedy the shortcomings of the current media avenues set forth above. The present invention seeks to provide people with a source of statistical information having many features never before provided.

In a first aspect, the present invention is drawn to a system for obtaining personal information of a user. The parameters eligible to be said information are virtually infinite as a primary purpose of the system is to compile a database of many pieces and types of user information, as will elaborated below.

Moreover, the system of the present invention may allow for information to be input with a desired level of specificity on the part of the user. This may help to ensure user confidence in their anonymity.

In a second aspect, the present invention is drawn to a system for obtaining sensitive information. Since a user is not required to input any conventionally identifying information, such as their name, social security number, phone number, financial information, address, email address, or the like, the fear of being associated with other sensitive information, such as medical records, criminal records, or the like is virtually eliminated.

In a third aspect, the present invention is drawn to a system for providing reliable statistical information. Since a user may directly access raw data, a large source of skepticism concerning statistical information broadcast as conclusions is eliminated.

In a fourth aspect, the present invention is drawn to a system for providing users with the ability to choose from a wide array of statistically relevant databases and construct a statistical representation (e.g. chart, graph, table) having a user selected number of dimensions correlating the chosen databases. The statistically relevant databases may include but are not limited to user personal profile information, user voting history, user contributed non-personal data, system records, and time. A user can select any number of databases and any number of available degrees within any database for correlation, as will be explained later. These databases and other parameters are generally referred to herein as “filters.” Specifically, a filter is any parameter that can be utilized in a statistical correlation.

In a fifth aspect, the present invention is drawn to a system in which users may cast votes on polls. The polls may be drawn to any number of topics including but not limited to current events, politics, and medicine.

In a sixth aspect, the present invention is drawn to a system which allows users to conveniently convey suggestions to administrators and allows administrators to conveniently incorporate such suggestions.

### BRIEF DESCRIPTION OF DRAWINGS

FIG. 1 is a sample suggestion interface according to an example embodiment of the present invention.

FIG. 2 is a research interface according to an example embodiment of the present invention.

FIG. 3A is a first sample interface in a first sequence of statistical analysis according to an example embodiment of the present invention.

FIG. 3B is a second sample interface in the first sequence of statistical analysis according to an example embodiment of the present invention.

FIG. 3C is a third sample interface in the first sequence of statistical analysis according to an example embodiment of the present invention.

FIG. 3D is an alternate third sample interface in the first sequence of statistical analysis according to an example embodiment of the present invention.

FIG. 4 is an alternate sample interface of statistical analysis according to an example embodiment of the present invention.

FIG. 5A is a first sample interface in a second sequence of statistical analysis according to an example embodiment of the present invention.

FIG. 5B is a second sample interface in a second sequence of statistical analysis according to an example embodiment of the present invention.

FIG. 6 is a further alternate sample interface of statistical analysis according to an example embodiment of the present invention.

### DETAILED DESCRIPTION

A user may input information into the system of the present invention in the form of a personal profile to be stored and associated with the user's account. Hereafter, such a user may be referred to as a member. The personal information may include but is not limited to information relating to the user's age, gender, race, residential location, religion, ethnicity, medical history, education, sexual orientation, criminal history, employment, family, marital status, political affiliations, income, tax status or history, spending habits, personal preferences, primary source of information, travel history, property, skills, hobbies, citizenship, involvement in charitable activities, and involvement in political activities.

A user may elect to characterize their personal information with only as much specificity as they desire. For example, in the category of age, a user may choose to indicate their birthday, their age, or an age range having upper and lower limits of their choosing. As another example, in the category of residential location, a user may choose to indicate their city of residence or perhaps only their country of residence or any other degree of locational specificity they desire. A user may elect to input only a username and password into their personal profile or other input for establishing a unique individual account. For increased reliability of statistical information, a user may input identifying information such as their name or social security number. This may be performed in a secure setting. Such a user may be said to be a confirmed user or the like. Directly identifying information may further be appropriate where the system is used for a private organization, as will be discussed below. There are virtually infinite categories for such information. A member profile or information contained therein may be associated with the time it was created or input, to be used as a filter, as will be explained later. At any time, a user may edit their personal profile by adding or removing information.

The personal information may be normalized for user input. As used herein, normalized input is understood to mean a type of input which a computer can evaluate simply. Such normalized inputs may include but are not limited to numerical inputs or selectable options from a finite list of choices (i.e. a pull-down menu, checklist, multiple choice question, etc, or combinations thereof). This differs from conventional website user profiles which only allow a user to input relatively few pieces of basic information in a normalized manner. While such conventional profiles may allow for a user to input any information they wish, if one were to want to input information other than the few normalized types, it must be entered in freeform. Such structures of information are difficult to incorporate into computer generated statistical analyses as the style of describing the information therein is subject to each users' preference and may vary greatly between users. It is contemplated though that a portion of a user's profile may be left to be filled in freely in addition to the normalized portions.

To enable input of the normalized portion of a profile, a browsable menu is provided from which a user may make selections and otherwise input data to describe themselves. If a user desires to input personal information of a category which is not available in the software, the user may suggest and/or create a new category which would then be available for all users to interface with. A user suggested category may be subject to edit or approval by administrators or an automated function.

Each piece of data input by a user or otherwise collected is herein referred to as a filter. Filters are used to create and manipulate statistical representations, as will be discussed below. Some filters may incorporate sub-filters. For example, with regards to location information, ‘North America’ may be a filter, and ‘United States’ may be a sub-filter, since it qualifies the information of the filter. Sub-filters may also include further sub-filters. In the above example, ‘New York’ may be a sub-filter of ‘United States’. There is no limit to the number of levels deep that filters may include further sub-filters. Such a relationship is hereafter referred to as a parent/child relationship of filters.

Every parent filter and child filter may be used as a filter, as will be described below. Accordingly, the term ‘filter’ is used hereafter to indiscriminately refer to both parent filters and child filters. A child filter may be referred to as the ‘value’ of its parent filter. Thus, in the above example, ‘United States’ is a value of ‘North America’. That is, the value further qualifies the filter while being capable of having values of its own. Also, even the highest filter in a parent/child chain (i.e. the filter having no parent) is a value.

As used herein, the term ‘value’ may refer to a variety of types of data. The value of a filter may be a statement of true or false, the response to a poll query, a numerical value, or a subset within a filter category to which an associated user belongs. This is not an exhaustive list.

While the above discussion is drawn to profile information related to a user, this need not necessarily be the case. The aforementioned profile information may describe the features of any article. For example, the database may comprise a collection of food recipes in place of users. In such an example, each filter may then be a feature of a subset of recipes, such as ingredients, nutrition information, or the like. An article containing a value in its profile is said to ‘have’ the filter invoked by that value. The system of the present invention, when comprising a database of non-user articles may function similarly to the system when comprising users as articles.

A primary function of the system is to enable a user to create visual representations of statistical information. The visual representations may include but are not limited to line graphs, bar graphs, pie charts, tables, combinations thereof, or any other form of data representation. The visual representations may correlate a user selected number of filters.

The system stores the data in a database used to correlate the features from the profiles of various articles at the request of a user. There are many data structures which can be employed to enable such a function. For example, all of the data may be stored in a single browsable table which the system uses to identify users having selected features. Alternately, separate tables may be used to store the data associated with each article, each table corresponding to a different article. Alternately, separate tables may be used to store the articles associated with each filter category, each table corresponding to a different filter category. Alternately, cooperating tables may be used to store users, filter categories, and linking information, respectively. Additionally, a table or function may be used to establish the parent/child relationship of the various filters or filter tables. Alternately, a NoSQL or non-SQL type database such as an object oriented database may be used. Alternately, a combination of the above types of databases may be used. This is not an exhaustive list.

As mentioned above, a user may suggest or directly add a new filter into the provided menu. Thus, such an activity may provoke creation of an additional object, database, or an additional table, column, row, or field of entry in a given database, or the like. Thus, it is easy and convenient for an administrator to incorporate the suggestion, as the infrastructure for incorporation is already in place. Such suggestions, their incorporation, and any other activity within the system may be time-stamped for use as a time filter, as will be explained below.

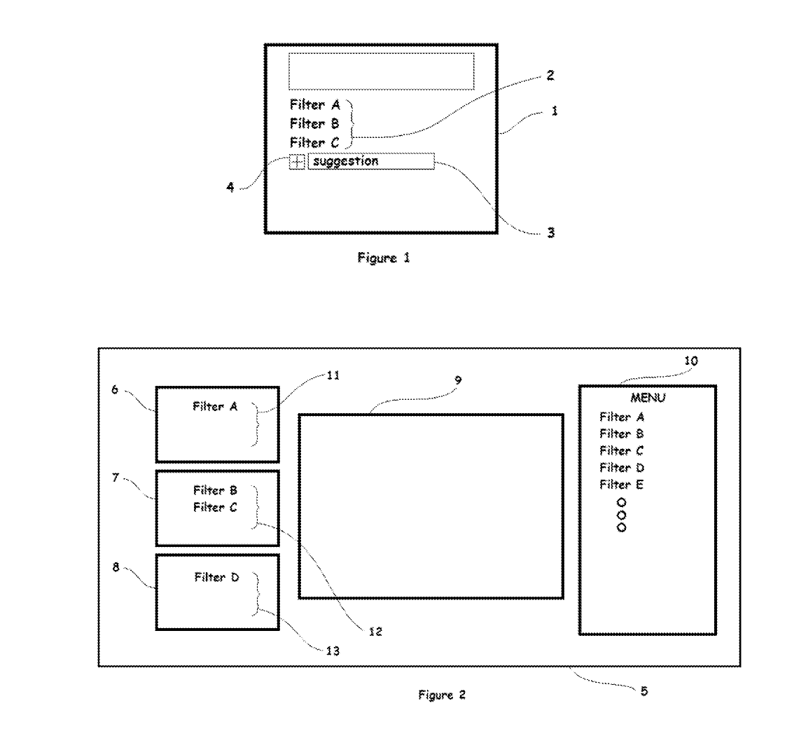

For efficiently enabling user suggestions or additions, the interface for these activities is located in the precise environment in which the element to be added, or otherwise edited, is relevant. For example, a user may be provided with dedicated mechanisms, such as a hyperlinks and/or text input boxes, for suggesting new filters, new voting options, and other features. A sample for location of a user suggestion for a new filter can be seen in FIG. 1.

FIG. 1 shows an environment (1) in which filters to be selected may be presented. The environment contains a plurality of selectable filters (2), a suggestion field (3), and in a preferred embodiment, an action button (4) which provides a user with at least one option for making a suggestion. The environment (1) may be that of a polling query, filter menu, sub-filter menu, or the like.

With reference to FIG. 2, a preferred embodiment of a user interface (5) for the system of the present invention is shown. There are three filter fields; a primary field (6), a secondary field (7), and a tertiary field (8). There is a representation area (9) in which a statistical representation is displayed. There is a menu area (10) in which a browsable filter menu is displayed from which a user may make filter selections. Not all of the fields or areas need be viewable by a user at the same time. The three fields are for displaying three filter selections. A selection may comprise a single filter or a group of filters, as will be elaborated on below. It should be noted that not all three selections need be made for the system to function. It should further be noted that the selections may be made in any order. A first selection (11) is directed to be displayed in the primary field (6). This selection governs the primary element to be represented. For example, the primary element to be represented may be a count of the number of articles in a set. A second selection (12) is directed to be displayed in the secondary field (7). This selection governs what will be hereafter referred to as the breakdown. For example, if a user desires to create a statistical representation comparing the set of articles having filter A with the set of articles having filter B, the selection of filter A and filter B would be made as part of the second selection. A third selection (13) is directed to be displayed in the tertiary field (8). This selection governs the population of articles to be considered in the statistical representation. For example, if a user desires to create a statistical representation comparing various subsets of articles, limited to articles having filter C, the selection of filter C would be made as part of the third selection.

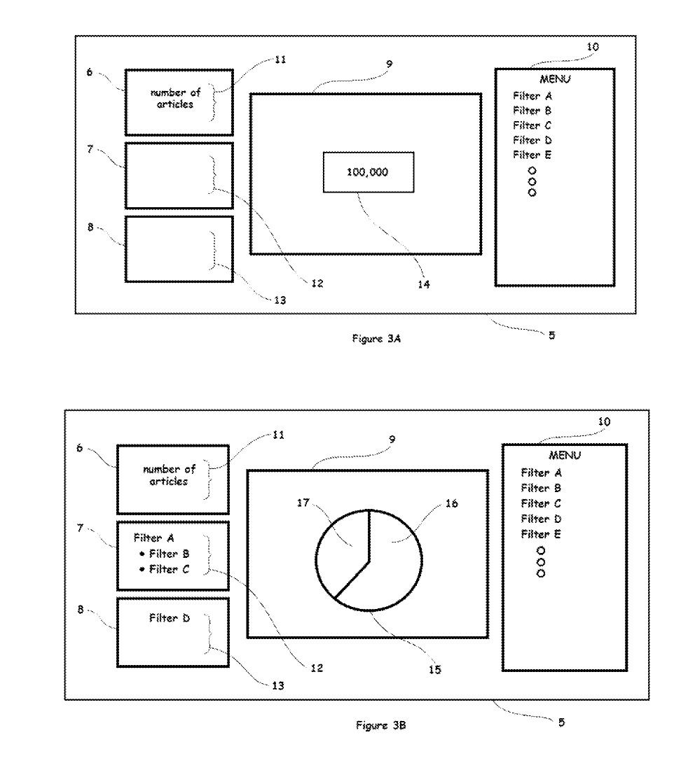

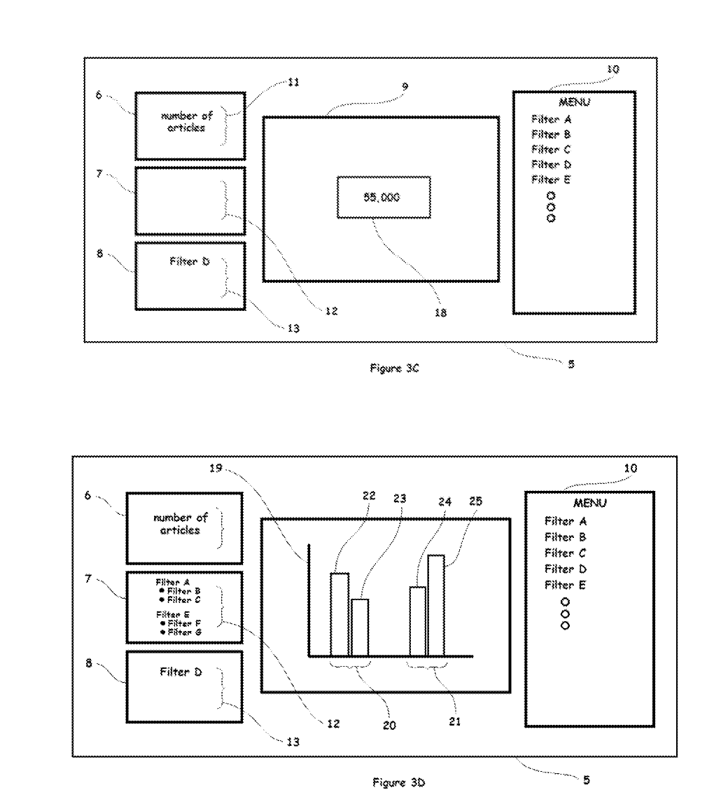

With reference to FIGS. 3A-3D, a sequence of the creation of a sample statistical representation is shown. First, a user would navigate to the interface (5), as seen in FIG. 3A. The user may browse the filter menu (10) to make a selection. In the present example, the user has selected “number of articles” as the first selection (11). Alternately, this first selection may already be made by default upon navigating to the interface (5). At this point, the system is only being tasked to count the set of all articles. Since no second or third selections have yet been made, there is no breakdown or limit to consider. Accordingly, the representation area displays a simple table (14) having only one value; the total number of articles. Next, the user may browse the filter menu (10) again and make a second selection (12), as seen in FIG. 3B. In the present example, the user has selected filter A, a filter having two immediate values; filter B and filter C, within it. At this point, the system is tasked to count the number of articles (since that is the primary filter) having filter B and count the number of articles having filter C for comparison. Accordingly, the representation area (9) displays a pie chart (15) comparing the number of articles having filter B to the number of articles having filter C. The choice of a pie chart as opposed to any other type of chart or table will be discussed below. Next, the user may browse the filter menu (10) again and make a third selection (13). In the present example, the user has selected filter D. At this point, the system is tasked to update the displayed representation (15) such that only articles having filter D are represented. In other words, the first slice of the pie chart (16) would represent the number of articles having filter B and filter D and the second slice of the pie chart (17) represent the number of articles having filter C and filter D.

For clarity, the following example is provided. In this example the articles are users and the profiles describe the users' characteristics. A user having navigated to the interface (5) is presented with the primary field (6) indicating “number of users” as the first selection (11) and the representation area (9) indicating a total number of users as a numerical value. The secondary field and tertiary fields are empty. The user browses the filter menu and selects the filter “female” and designates this selection as the third selection (13). The numerical value in the representation area updates to a new value, the new value representing the number of users who have added the trait “female” to their profile. The tertiary field (8) updates to indicate that the filter “female” has been selected. The user further selects “occupation” as a filter and designates this selection as the second selection (12). For this example, assume the filter “occupation” has the values doctor, lawyer, and banker as its values. The representation area updates to display a pie chart, each slice of which representing a number of female users who have added each of the three occupations to their profiles respectively. A first slice representing the number of female doctors, the second slice representing the number of female lawyers, and so on. Of course, more values may be present under the parent filter “occupation” and the user may select only the values they wish to be represented in the chart. The user may continue to select filters, designating them to be incorporated into the second or third selections as desired and the above described effects will repeat, either narrowing the scope of the representation to only reflect users who have added a “third selection” filter to their profile or further breaking down the representation into added dimensions to represent users having added a value of a “second filter” selection to their profile. The process may also be undone in steps by removing a filter from either selection.

It should be noted that a statistical representation having only a single numerical value as its output is said to comprise one parameter. A statistical representation having anything more than a single numerical value as its output, such as a pie chart, is said to comprise multiple parameters.

In a further example, shown in FIG. 3C, the user may unselect filter A from the second selection, thereby unselecting filter B and filter C along with it. At this point the system is tasked to count the number of articles, limited to those having filter D. Accordingly, the output may once again be a simple table (18) having only one value. Alternately, the user may have unselected only a subset of values within the breakdown filter(s) causing the system to present a breakdown of the remaining filters.

In an alternate further example, shown in FIG. 3D, the user may select an additional filter as part of the second selection (12). In the present example, the user has selected filter E, having two immediate values; filter F and filter G, within it. At this point, the system is tasked to compare the number of articles having filter B to the number of articles having filter C while simultaneously comparing the number of articles having filter F to the number of articles having filter G. Accordingly, the representation area displays a graph (19) having an additional dimension to accommodate the additional breakdown. In the present example, a bar graph (19) is displayed. A first set of bars (20) represents articles having filter B, while a second set of bars (21) represents articles having filter C. Each set of bars contains a bar representing articles having filter F and a bar representing articles having filter G. Particularly, bar 22 and bar 24 represent articles having filter F, and bar 23 and bar 25 represent articles having filter G. All the bars are further limited to articles having filter D, as that selection is also present. Thus, bar (22), for example, represents the number of articles having filter B and filter F and filter D.

Mathematical operations may be performed with the data of a filter and the result used as a filter. Such mathematical operations include but are not limited to an average, maximum, minimum, percentage, or ratio of a filter, or combination thereof. For example, a statistical representation may represent the average income of a population or the maximum, average lifespan of a population. At its core in this aspect, the system is counting articles which satisfy criteria and outputting numerical values. Thus, incorporating a mathematical operation performed on such a numerical value is simple.

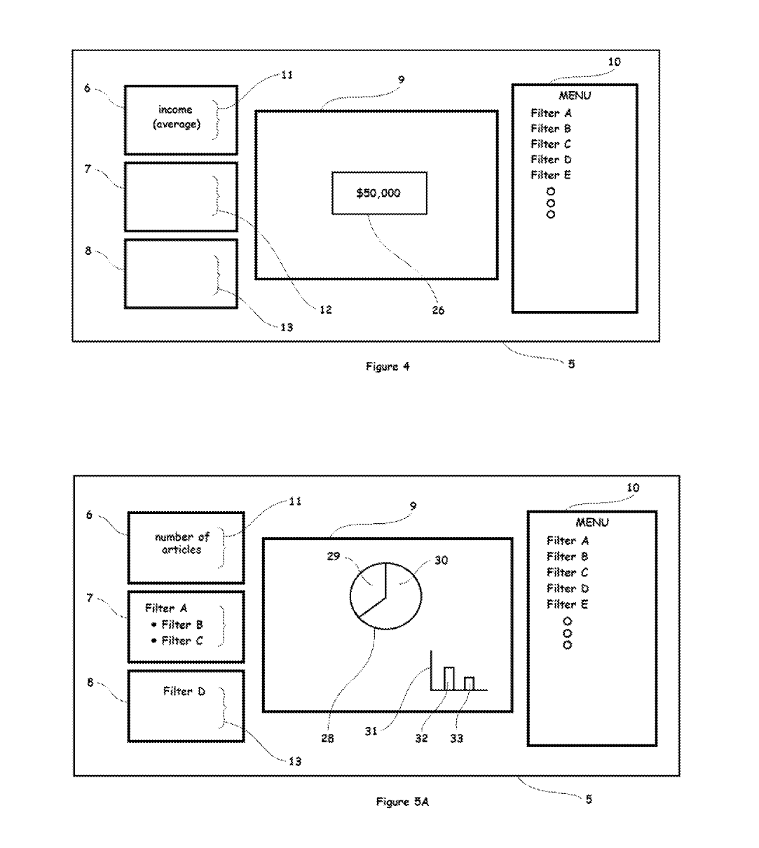

FIG. 4 shows an example of a variation with respect to the first selection. In this example, the filter ‘income’ is selected as the first selection (11). Moreover, the mathematical operation ‘average’ is applied to it. At this point, the system is tasked to identify all articles having a value for the filter ‘income’, determine what the value is, and calculate the average value. The output is once again a simple table (26) having one value. This example can further be modified by making a second or third selection to construct a representation having consideration of a breakdown or limit. For example, by making a second selection, the system may be tasked to display a chart comparing the average income of the set of articles having filter B with the average income of the set of articles having filter C. By making a third selection, the system may be tasked to display a chart limiting either of the aforementioned charts to articles having filter D.

Filters can be grouped for simultaneous consideration. For example, consider a statistical representation comprising a plurality of elements (e.g. a bar graph with two bars), each representing a subset of articles which satisfy particular criteria. With filter grouping, the first element (bar) may represent the number of articles which have filters A AND B AND C, while the second element (bar) may represent the number of articles which have filters D AND E AND F, or the second element may represent the number of articles who have filters A AND E AND F, or the like. Such grouping is said to be performed with a logical AND. Alternately, or in combination, the grouping may be performed with a logical OR. For example, an element may represent the number of articles which have filters A AND B OR C AND D ((A AND B) OR (C AND D)). With or without filter grouping, the system operates by browsing the databases and counting the number of articles which satisfy the selected criteria.

As mentioned above, any number of filters may be selected for any of the three selections. By default, the software chooses a chart type based on the number, types, and values of selected filters. In a preferred embodiment, the system chooses a chart type from a predefined set of chart types having exactly the number of dimensions required by the analysis. As used herein, the term ‘dimension’ need not necessarily refer to a spatial dimension. Rather, the number of dimensions a chart type has corresponds to the number of parameters it can compare. For example, a standard pie chart has one dimension, since it only compares values of one filter. A bar graph may have more dimensions. An example of such a bar graph was discussed above with reference to FIG. 3D. Further dimensions may be realized by incorporating colors or shading patterns to accommodate distinctions between values of additional filters on a single graph. Other means are contemplated as well. Additionally, percentages or absolute values may be superimposed on a chart where appropriate. Alternately, a user may select from a predetermined selection of chart types. Depending on the information being represented, a user may prefer to employ a table, a pie chart, a bar graph, or any of numerous chart types, or a combination thereof. A combination chart type may be, for example, a pie chart with each slice raised a respective amount along a vertical axis, the height of which corresponds to another dimension of analysis (i.e. another filter). As such, multidimensional analysis is easily performed.

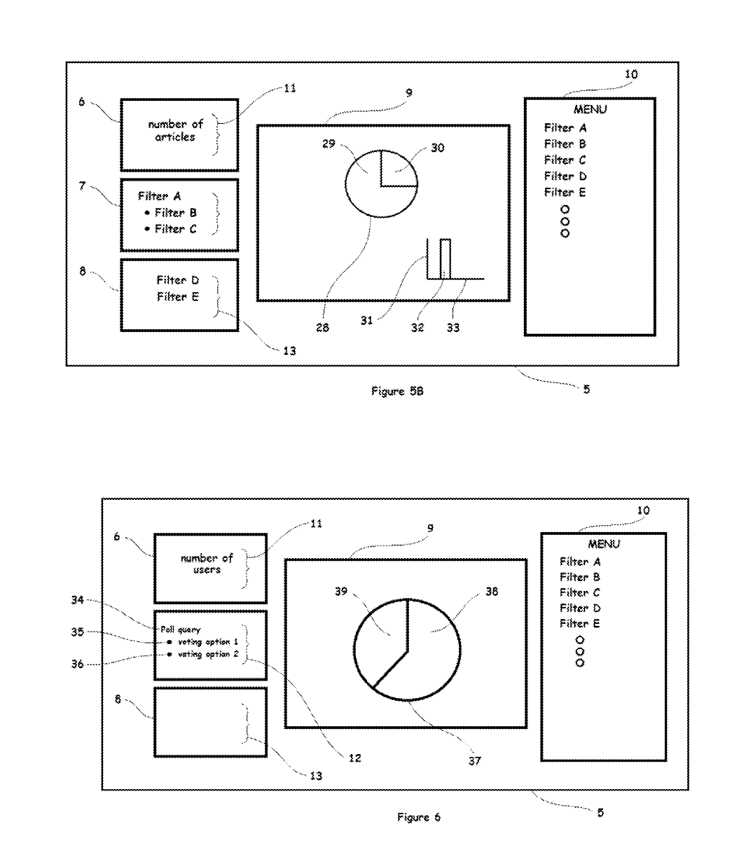

It has been mentioned that a user may add filters by browsing a filter menu, but this is not the only way. Another method may be to search for a desired filter using a search function in which a user enters a search query and the system returns potential matches. Yet another way of adding filters is by ‘probing’ a representation. Looking now at FIG. 5A, consider a representation (27) comprising more than one chart. Primary chart (28) represents articles having filter A and compares articles having filter B (29) and filter C (30), values of filter A, limited to those articles having filter E. Auxiliary chart (31) represents articles having filter E and compares articles having filter F (32) and filter G (33), values of filter E, limited to those articles having filter A. The three fields 6, 7, and 8, correspond to the construction of primary chart (28). Auxiliary chart (31) may be offered by the system or preselected to accompany certain types of analyses. A user could select a particular demographic, for example, by clicking on a portion of a chart representing the desired demographic, and the one or more charts may update to reflect having been qualified by the selected demographic. For example, a user could click on the portion of chart (31) representing articles having filter F (32), thereby adding filter F into the third selection (13) and causing at least chart (28) to update accordingly, as seen in FIG. 5B. The same technique can be used to edit the first and second selections by clicking on appropriate areas of the representation. This technique is herein referred to as probing of a chart subset. Such probing may be performed in succession to probe a desired number of levels deep into a chart.

A user need not necessarily create a statistical representation from scratch. A user may navigate to a stored existing representation and edit it using the same techniques discussed above. In this manner, a user can easily create a desired statistical construction by starting from an already available construction and probing into subsets of the representation and by adding or subtracting filters of their choice. It should be noted that one need not log in or even create an account as described above in order to view statistical results or create statistical representations.

Polls of various natures may be available for users to cast votes. The poll topics may include but are not limited to current events, politics, market research, and medicine. The polls may be categorized by topic and/or user creation and/or popularity and/or other metrics. A user may or may not need to log in, become a member, or enter other information in order to respond to polls. A vote cast by a non-member may be marked as a visitor vote where the feature of being a visitor may be used as a filter. Upon submission of a poll response, a user may be prompted to enter some particular information of interest to the poll creator or administrator, or to become a member. A vote cast by a member or user who entered personal information may be associated with the member's profile or user's information. Additionally, the vote cast may be associated with the time the vote was cast. Such time information may be incorporated into further statistical correlations.

It is important to note that a construction need not necessarily include polling information at all. It could contain exclusively personal profile information or other non-polling information. For example, using the system of the present invention, a user could easily correlate the frequency of persons having filter A to a region.

Polls may be created by the system administrators or by users. A poll creator may invite members of a demographic to respond to their poll. Such invitations may be directed specifically to members having a particular filter associated with their personal profile or otherwise displayed on the system for users to view. For example, if one were interested in a policy opinion of those who have filter A, they may invite those with a filter A indication on their personal profile to respond to their policy poll. In this example, the articles are users. Additionally, a message may be displayed for all or some users to see indicating the presence of a targeted poll. As such, a user can easily obtain valuable information from those who may be members of a demographic which may be difficult to locate or identify and who may have the most relevant information. A user may also select which filters as the basis for an invitation they want to alert them and in what manner, so as to not be bothered by excessive invitations. For example, a user can join or browse the content of a ‘community’ for users who share a particular filter or group of filters (though the user need not necessarily have the filter) and thus receive prompts, updates, messages, polls, or the like intended for members of that community. Similarly, a user can broadcast the same to members of the community. Additionally, a poll creator may restrict other users from casting votes on their poll based on the profiles or other account information of the users.

Each vote cast toward a poll serves as a filter as it is another piece of information associated with the user who cast the vote. Accordingly, it serves as part of a user's profile. Thus, interfacing with a poll's results is similar to interfacing with any other statistical representation. Upon navigating to a poll, a user has automatically made a number of filter selections. A first selection has automatically been made since the poll may already be counting users, though other polls are possible. A second selection has automatically been made since the breakdown already consists of the filters that comprise the voting options. FIG. 6 shows a sample interface of a user having navigated to a poll before necessarily making any further selections. The second selection (12) comprises a first filter (34), the poll query, and second and third filters (35) and (36), the available voting options. The displayed representation is that of a chart (37) showing users having voted on the poll, (i.e. having the first filter) and comparing the number of users voting for each of the voting options (i.e. having the second and third filters, respectively) as a first (38) and second (39) element in the chart (37).

This representation is then editable much the same as any other representation. A particular poll may be a filter, while the various voting options for that particular poll are values. Such voting options may be yes, no, the name of an individual or group, a numerical rating or any other conceivable voting option to a poll. It should be noted that the various voting options to a poll need not necessarily be exclusive. It is conceivable for a poll response to include a plurality of voting choices simultaneously; for example, when asked to order a group of things by a given user-subjective metric or when asked to choose a plurality of options that satisfy user-subjective criteria.

For clarity, the following example is provided: A user having navigated to the interface (5) via a poll selection is presented with the primary field indicating “number of users” as the first selection (11), the secondary field indicating the poll itself as the second selection (12) and the representation area displaying a pie chart with each slice representing the amount of users who have voted for each of the poll options. In this example, assume the poll has two options for response; yes and no. Thus, the second selection, the poll itself, is in fact a selection of yes and no. The user browses the filter menu and selects the filter “female” and designates this selection as the third selection (13). The pie chart updates to represent only users who have added the trait “female” to their profile; each slice now representing female voters who voted “yes” and female voters who voted “no”, respectively. The tertiary field (8) updates to indicate that the filter “female” has been selected. The user browses the filter menu and selects “married” and designates this selection as the third selection (13). The pie chart updates to represent only users who have added the trait “married” to their profile; each slice now representing married, female voters who voted “yes” and married female voters who voted “no”, respectively. The tertiary field (8) updates to indicate that the filter “married” has been selected. This may be repeated as desired. Filters may be added to the second selection as well. For example, by selecting “occupation” similarly to the previous example, the representation may update to display a bar graph having three sets of two bars. The first set of bars representing the number of married, female, doctors who voted “yes” and “no”, respectively, the second set of bars representing the number of married, female, lawyers who voted “yes” and “no”, respectively, and so on.

Upon navigating to the poll, a user may be presented with one or more default charts which correlate that poll's information to one or more filters, respectively. A default chart may include, for example, a line graph showing the age distribution of the users who cast votes for that particular poll. It should be noted that the default filters and chart types may be replaced by those of a user's choosing throughout creation of the construction. Furthermore, a user may edit their account in a manner so as to choose what the default filters or chart types will be when they access, create, or probe a construction. A user may also probe a representation by interfacing with the default charts similarly to the manner in which one may interface with the primary representation. A user could then add any filters displayed in the default charts simply by selecting a default chart or an area thereof and automatically create new default style charts correlating the chosen filter(s) with the poll information. A default style chart may be a predetermined chart type assumed to easily communicate a particular type of data. For example, a user may select the “female” slice of a gender pie chart, thereby having selected the filter “female”.

Similarly to the suggestion of a filter edit, a user may suggest edits of a poll. A user suggested poll edit, such as the suggestion of a new voting option, may be subject to edit or approval by administrators, and/or an automated function, and/or the poll creator. This may be facilitated by prompting the poll creator of the suggestion. In a preferred embodiment, the suggestion interface is located in the precise environment in which the element to be added, or otherwise edited, is relevant. In order to assure accuracy of results over changing polls, a prompt may be sent to all users who have already cast votes on a changed poll. This prompt may inform the users of the change and may further allow them to recast their vote if desired with consideration of the change.

As can be appreciated from the present disclosure, there is a virtually unlimited number of possible filters and values. Thus, there is an even larger number of possible combinations of filters. Many filters may arise from context. For example, a member's personal profile may keep track of the user's voting positions and record any changes. Thus, a change in a particular vote may be used as a filter. It can further be qualified to filter changes from a specific position(s) to another. A number of times a user has changed positions on a particular poll(s) or overall or in a designated period may be a filter as well. A change in user information may also be made at any time to parameters other than votes cast. For example, a user may update their salary in their profile as is appropriate to accurately reflect their current status. The system would store and timestamp all values of the parameter ever entered. Such a database may, for example, be used to track an individual's changing status (e.g. change in salary) over time. As another example, such a database may be incorporated into a statistical construction including other such databases. As such, a statistical analysis may be performed to correlate the change in salaries for various professions over time, for example.

Additionally, the negative of any filter (i.e. one who is not positively associated with a particular filter) may be used as a filter. Additionally, the fact that a filter cell has any value at all may be used as a filter, regardless of what the value is. For example, a user can filter results based on users who have entered any information into some particular filter database (e.g. they have entered location data into their profile, regardless of what the location data is.)

A notable combination of filters unique to the software of the present invention may include a plurality of polling queries whereby one can correlate users having a particular response to one polling query with users having a particular response to at least one other polling query.

Other filters may include, system records, number of users, number of members, confirmed users, and usernames. In such a way, direct access to raw data may be achieved, for example, by allowing users to view a listing of every user whose information contributed to a result or even by granting users read-only access to the personal profiles of other users.

Other filters may comprise user contributed non-personal data. A user may upload their own databases, for example by filling in an available chart or timeline structured to be compatible with the software. Such databases may be only available to the user who uploaded them or may be shared with other users. These databases may be used in the same manner as other filters or superimposed onto constructions, as may be desirable for a timeline.

Some filters may include ranges of values wherein a range can be used as a filter. For example, age may be a filter, while 45 years old and 20-27 years old may be a value and a value range, respectively. A statistical representation may include a filter selection comprising a value range, for example, to limit the considered data to that associated with articles having a filter within the desired range.

As mentioned above, all data collected or input may be time-stamped for logging the time it was entered into the database. Such time values may also be used as filters. For example, time may be incorporated into the second filter selection to create a breakdown of an article subset over time. As another example, time may be incorporated into the third filter selection to limit the data of a representation to articles having a particular filter associated with a chosen range of time. Some filters, such as time, may have more user selectable aspects than just values. For example, with regards to time, a user could select the time increment to be represented as well as the specific values. Such increments may include but are not limited to days, months, years, continuous, etc.

A user interface may be provided such that a user could toggle a single filter and watch the other charts update in “real time.” For example, while viewing a representation of polling results or another data category, a user may toggle a time interface (e.g. slide, dial) which may automatically cause the chart of the representation to update and portray its statistics at the chosen time. As another example, a user could perform a similar function while toggling a “number of members” or “number of votes cast” interface. Alternately, a user may create a static chart including time or another filter as a dimension (e.g. on an axis) in order to see the evolution of poll results or other statistics.

A user may choose to edit a construction. For example, a user may be able to swap filter axes, add labels, provide legends, edit colors, etc. A user may be able to rotate their construction to their preference. This may be particularly useful in the case of a chart type having three spatial dimensions. Major events may be incorporated into a construction. For example, a user may include an indication of election days, natural disasters, or any other event on a timeline correlating user opinions on a poll.

Some filters may be associated, at a user's selection, with a particular type of graph feature. For example, a construction correlating two filters; one of which is the states of the United States of America, may be embodied as a map of the United States with each state having an indication associated with it representing its value as a function of the other filter. Such an indication may be, for example, a percentage or numerical value printed on or near an associated state, a color or color gradient, an amount a state is raised from the base of the map in a manner similar to a bar graph. Many other such specialized chart types and elements are possible.

A user may save constructions in their account and/or in a publicly accessible area for later reference or editing. A user may set a notification if a particular aspect of a construction exceeds or falls below a desired threshold.

Besides creating constructions of the types listed above, a user could use the filters for other purposes such as finding polls or users they are likely to be interested by. For example, by correlating a filter indicating a number of votes cast for polls and a filter(s) from the users own personal profile, a user can view the polls for which those with whom the user shares particulars of personal information have been voting. For example, one could easily view the most popular polls in their home region or of their ethnicity or of people who agreed with their position on another poll or of any other conceivable demographic. Additionally, a user can easily find which users have been posting polls they are likely to be interested in. A user may then be able to navigate to the desired user's polls or set alerts to be notified of the desired user's activity, such as poll creation or participation. Such features may not require a user to create a construction from scratch.

As mentioned above, a user may save a construction to a public area viewable by other users. In this area, users may publish polls, constructions, comments, events, or any other information to be broadcast. The published items may be marked at the creator's choice by tags including filters with which the item was created, filters about which the item may be relevant, or other filters dedicated to classifying items. Not all of the filter categories for tagging necessarily come from those available to incorporate into article profiles. Using the filter system, a user can browse the public area for content that pertains to them or otherwise interests them. Furthermore, an item may be associated with the user who created it and is thus associated with the profile of the creator. Thus, the filter system may also be used to browse for content that was published by another user having particular filter traits that are of interest to the browsing user. In other words, the public area may be browsed for content tagged with filter A, content published by a user having filter A, or a combination thereof.

A user may declare user-selectable groups of filters as saved filter groupings for later usage in the filter selections. For example, a user who often sorts data or items according to the same filters may group these filters as a saved filter grouping, enabling the user to select the saved filter grouping and thereby have selected all of the filters in the grouping without needing to individually select each one.

### INDUSTRIAL APPLICABILITY

Generally, the system of the present invention could be used to survey populations, promote participation, conduct statistical research, and facilitate unique communities and communications. The system may be embodied as a website for mass population access and utilization. Alternately, the system may be embodied as personal software such that it can be used by a private organization to enable all of the utilities of the system exclusively within the group of the private organization. Such a system may conveniently allow for the inclusion of filters, publishing of polls, or broadcasting of information uniquely pertinent to said organization and its members. Alternately, the system may be embodied as personal software such that it can be used by an individual person to enable the person to track their own activity or conduct statistical research relating to their own behavior, inputs, or uploaded data. Alternately, the system may be embodied as a collection of non-user articles and their respective details, to enable efficient statistical research within a defined group of things. Additionally, any of the aforementioned embodiments would enable efficient browsing for subsets of articles, whether they be users or non-user articles, based on the article traits.

The present invention enables the targeting of demographics for general contact. For example, users, website administrators, and/or others may send targeted messages, alerts, or the like to users. Moreover, even an essentially singular message or alert may be tailored based on a specific user's profile. For example, an alert that generally warns a user of their risk for a medical condition may present different numbers to different users based on an assessment of the individual risk of each user.

In any of the aforementioned embodiments, the system may require approval by an administrator to allow for the addition, subtraction, or editing of filters or values therein. Alternately, as may be particularly preferable in the embodiment for individual persons, the system may be configured to automatically accept any such changes. A user may be able to sync their personal profiles across more than one of the three types of systems (for filters that are present in the more than one type of system) thus saving the user from inputting the same information into a plurality of interfaces. Alternately, a user may not sync their information in this manner.

Many aspects of the present invention refer to lists of elements which are not exhaustive as providing such lists would be unwieldy. It should be understood that many elements may be added to such lists without departing from the spirit or scope of the invention. Similarly, features describing the present invention with regards to a user interface or any other aspect are only discussed in the context of a preferred embodiment. Other variations of the present invention in any aspect are possible without departing from the spirit or scope of the present invention.

An example embodiment of the present invention is directed to one or more processors, which can be implemented using any conventional processing circuit and device or combination thereof, e.g., a Central Processing Unit (CPU) of a Personal Computer (PC) or other workstation processor, to execute code provided, e.g., on a hardware computer-readable medium including any conventional memory device, to perform any of the methods described herein, alone or in combination, and/or to generate any of the user interface displays described herein, alone or in combination. The one or more processors can be embodied in a server or user terminal or combination thereof. The user terminal can be embodied, for example, as a desktop, laptop, hand-held device, Personal Digital Assistant (PDA), television set-top Internet appliance, mobile telephone, smart phone, etc., or as a combination of one or more thereof. Additionally, some of the described methods can be performed by a processor on one device or terminal and using a first memory, while other methods can be performed by a processor on another device and using, for example, a different memory.

The memory device can include any conventional permanent and/or temporary memory circuits or combination thereof, a non-exhaustive list of which includes Random Access Memory (RAM), Read Only Memory (ROM), Compact Disks (CD), Digital Versatile Disk (DVD), and magnetic tape.

An example embodiment of the present invention is directed to one or more hardware computer-readable media, e.g., as described above, on which are stored instructions executable by a processor to perform the methods and/or provide the user interface features described herein.

An example embodiment of the present invention is directed to a method, e.g., of a hardware component or machine, of transmitting instructions executable by a processor to perform the methods and/or provide the user interface features described herein.

The above description is intended to be illustrative, and not restrictive. Those skilled in the art can appreciate from the foregoing description that the present invention may be implemented in a variety of forms, and that the various embodiments may be implemented alone or in combination. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and following claims.

What is claimed is:

1. A computer system comprising:
a computer processor configured to:
obtain profile information of a plurality of information categories regarding a plurality of articles;
store the obtained profile information in a database, with associations of subsets of the obtained profile information with respective ones of the plurality of information categories, wherein each of at least some of the plurality of information categories is independently user-selectable as a filter; and
responsive to receipt of
(I) a first selection, as at least one filter criterion, comprising at least one of
(a) one or more of the at least some of the plurality of information categories, and
(b) one or more of value ranges within the one or more of the at least some of the plurality of information categories, and
(II) a second selection comprising at least one further informational category,
output a statistical representation of data of the further informational category limited to that of the data of the further informational category that is associated with those of the plurality of articles whose profile information satisfies the at least one filter criterion;
wherein the statistical representation represents a comparison of at least two portions of the subset of data.

2. The system of claim 1, wherein the articles are users and the profile information includes a plurality of profiles that each corresponds to a respective one of the users.

3. The system of claim 1, wherein:
the processor is configured to timestamp data of the obtained profile information and filter the time-stamped data according to time; and
the output statistical representation is limited by the filtering of the time-stamped data according to time.

4. The system of claim 1, wherein the processor is configured to timestamp receipt of the data of the further informational category, and receive input of one of a time value and a time range as a further filter criterion according to which the output is limited to those of the data whose timestamp satisfies the one of the time value and the time range.

5. The system of claim 2, wherein the processor is configured to:
output a graphical user-interactive time selection control manipulable by a user for selecting the one of the time value and the time range; and
dynamically modify the output statistical representation of data as the one of the time value and the time range is changed by the user manipulation of the time selection control.

6. The system of claim 1, wherein the data of the further informational category are responses by at least a subset of the plurality of users to a poll.

7. The system of claim 6, wherein:
the processor is configured to output a poll response interface including a poll question and a set of selectable responses that are selectable, at least one of alternately and in combination, by a user as one of the responses of the data of the further informational category; and
the poll response interface includes a user-selectable control for inputting a suggested new response option for responding to the poll question.

8. The system of claim 1, wherein the processor is configured to determine, based on the data of the further informational category, at least one of an average, a maximum, a minimum, a percentage, and a ratio, or a combination thereof, on which the statistical representation is based.

9. The system of claim 1, wherein the processor is configured to, subsequent to the output of the statistical representation,
at least one of
receive input of a selection of an additional filter criterion and
receive input of an instruction to remove a previously applied filter criterion, and
to responsively dynamically modify the output statistical representation.

10. The system of claim 1, wherein a presence of data regarding one of the plurality of information categories is one of the at least one filter criterion.

11. The system of claim 1, wherein an absence of data regarding one of the plurality of information categories is one of the at least one filter criterion.

12. The system of claim 1, wherein the processor is configured to output a listing of user-selectable category options, each corresponding to a respective one of the plurality of information categories, the information categories corresponding to the user-selected ones of listing being used by the processor as the at least one filter criterion.

13. The system of claim 12, wherein the user-selectable category options are output in a graphical interface that includes a control that is user selectable for defining a new category option for use as a filter criterion, in response to which definition, the processor is configured to update the listing.

14. The system of claim 1,
wherein the processor is further configured to receive a third selection comprising at least one filter;
wherein the filter of the third selection governs an aspect to be qualified by the first and second selections.

15. The system of claim 14,
wherein the third selection further comprises at least one mathematical operation;
wherein the mathematical operation is performed on the data associated with the filter of the third selection.

16. The system of claim 14,
wherein the filter of the third section is a user population, and the aspect to be qualified is the counting of the user population.

17. The system of claim 15,
wherein the filter of the third section is a not a number of users;
wherein the filter of the third selection is a filter whose values are numerical values.

18. The system of claim 1,
wherein the statistical representation comprises a plurality of elements, each element representing a number of articles that satisfy at least one of a plurality of values of the informational categories comprising the second selection;
wherein at least one element represents a grouping of filter selections;
wherein the grouping is defined by a selection of one or more joinders, the one or more joinders including at least one of a logical AND, a logical OR, and a combination thereof.

19. The system of claim 1,
wherein there is provided a graphical interface having a plurality of fields;
wherein there is provided a first field into which the first selection is directed;
wherein there is provided a second field into which the second selection is directed.

20. The system of claim 17,
wherein there is provided a third field into which a user may direct a third selection;
wherein the filter of the third selection governs an aspect to be qualified by the first and second selections
wherein the third filter selection comprises at least one of a filter and a mathematical operation.

21. The system of claim 1,
wherein the second selection further comprises at least one additional further informational category;
wherein the second selection comprises informational categories having at least two values therein.

22. The system of claim 1,
further comprising an account database having a plurality of accounts corresponding to a plurality of users;
wherein the plurality of users are able to input the obtained information.

23. A computer system comprising:
a computer processor configured to:
obtain profile information of a plurality of information categories regarding a plurality of users;
store the obtained profile information in a database, with associations of subsets of the obtained profile information with respective ones of the plurality of information categories, wherein each of at least some of the plurality of information categories are independently user-selectable as a filter; and
responsive to receipt of (I) selection, as a filter criterion, of one of the at least some of the plurality of information categories, and (II) selection of a further informational category, output a statistical distribution of data of the further informational category over a plurality of value ranges of the selected one of the information categories.
